(19) United States
(12) Patent Application Publication
(10) Pub. No.: US 2023/0187753 A1
(43) Pub. Date: Jun. 15, 2023

(54) Energy Store with a Defined Width

(71) Applicant: Bayerische Motoren Werke Aktiengesellschaft, Muenchen (DE)

(72) Inventors: Kilian FRIEDRICH, Muenchen (DE); Andreas KLAFFKI, Unterschleissheim (DE); Michael KREITZ, Haimhausen (DE); Matthias WAGNER, Muenchen (DE); Manuel WINKLER, Chemnitz (DE)

(21) Appl. No.: 18/080,881

(22) Filed: Dec. 14, 2022

(30) Foreign Application Priority Data
Dec. 15, 2021 (DE) 10 2021 133 296.6

(51) Int. Cl. H01M 50/213; H01M 50/51

(52) U.S. Cl. CPC H01M 50/213; H01M 50/51; H01M 2220/20

(57) ABSTRACT

An energy store for storing electrical energy includes storage cells in R rows and Q columns. The energy store is divided into Q/N sub-stores which each have R rows and N columns. Further, the energy store includes Q/N sub-contacting systems for the corresponding Q/N sub-stores. The sub-contacting system for a sub-store is configured in each case to interconnect the storage cells of the sub-store in question in accordance with an MP arrangement, in which the storage cells of sub-groups, each with M storage cells, are interconnected in parallel to one another. The energy store further includes Q/N−1 connection elements, via which the Q/N sub-stores are interconnected in series.

### CROSS REFERENCE TO RELATED APPLICATION

This application claims priority under 35 U.S.C. § 119 from German Patent Application No. 10 2021 133 296.6, filed Dec. 15, 2021, the entire disclosure of which is herein expressly incorporated by reference.

### BACKGROUND AND SUMMARY

The invention relates to an energy store with a defined store width, in particular for use in different vehicle models.

An at least partly electrically driven vehicle has an energy store for storing electrical energy for the operation of an electric drive motor of the vehicle. The energy store typically has a plurality of individual storage cells, in particular a plurality of round cells, which are arranged in a housing of the energy store.

An energy store can be provided for installation in different vehicle models which may each have different requirements in respect of the power supply. Furthermore, it may be desirable to provide energy stores that have different storage capacities, for example so as to be able to work with vehicles that have different ranges. Energy stores may thus be subject to different electrical requirements.

On the other hand, the width of the installation space that is provided for an energy store in motor vehicles, in particular in passenger vehicles, may be constant.

The provision of energy stores that have different electrical properties (in particular in respect of the storage capacity and/or in respect of the storage capacity and/or in respect of the discharge performance) typically requires the use of different electrical interconnections between the storage cells of the energy store (for example a 3P, a 4P or a 5P interconnection). This typically leads to energy stores that have different widths.

The present document addresses the technical problem of providing an energy store that can be adapted to different electrical requirements without having to adapt the width of the energy store.

The problem is solved by the claimed invention. It is noted that additional features of a claim dependent on an independent claim without the features of the independent claim or only in combination with some of the features of the independent claim can form a separate invention independent of the combination of all features of the independent claim that can be made part of the subject matter of an independent claim. This is true similarly for technical teaching described in the description, which can form an invention independent of the features of the independent claims.

According to one aspect, an energy store for storing electrical energy is described. The energy store can have a nominal voltage of 60V or more, or of 300V or more, in particular of 800V or more. The energy store can be designed to store electrical energy for the operation of a drive motor of a motor vehicle.

The energy store comprises (in particular precisely) R rows, each with (in particular precisely) Q columns of storage cells. In other words, the energy store can have a matrix of (in particular precisely) R×Q storage cells and/or storage cell places. The rows can each extend here along the longitudinal axis of the energy store, and the columns can extend along the transverse axis of the energy store, wherein the transverse axis is arranged perpendicularly to the longitudinal axis. The longitudinal axis can correspond for example to the longitudinal axis of the vehicle in which the energy store is installed, and the transverse axis can correspond to the transverse axis of the vehicle.

In a preferred example, the R rows and Q columns of storage cell spaces are occupied by (in particular precisely) one storage cell each. In this case the energy store comprises a total of R*Q storage cells. As described further below, however, it may be advantageous to leave storage cell spaces unoccupied sporadically.

The storage cells can each be circular-cylindrical and/or the storage cells can be round cells. The storage cells can be arranged next to one another in such a way that the storage cells each extend along the vertical axis of the energy store (which can correspond to the vertical axis of the vehicle in which the energy store is installed). The longitudinal axis, the transverse axis and the vertical axis can correspond to the axes of a Cartesian coordinate system.

The storage cells and/or the storage cell spaces (i.e., the spaces for the individual storage cells) can be arranged in a honeycomb pattern in the R rows and Q columns. Here, (in particular precisely) each cavity can be surrounded by (in particular precisely) three storage cells or storage cell spaces. Furthermore, (in particular precisely) each further storage cell or (in particular precisely) each further storage cell space can be surrounded by (in particular precisely) six storage cells or storage cell spaces.

The energy store can be divided into Q/N sub-stores, wherein each sub-store has (in particular precisely) R rows each with (in particular precisely) N columns of storage cells and/or storage cell spaces. Here, the Q/N sub-stores can be arranged next to one another along the transverse axis so that the first sub-store (i.e., the sub-store with the index number 1) is arranged on the first longitudinal edge and the Q/N^{th} sub-store (i.e. the sub-store with the index number Q/N) is arranged on the opposite second longitudinal edge of the energy store. Furthermore, the R rows of storage cells or storage cell spaces can be arranged along the longitudinal axis between the first transverse edge and the second transverse edge of the energy store.

The Q/N sub-stores can thus be arranged next to one another sequentially in accordance with the index numbers 1 to Q/N along the transverse axis of the energy store. Each of the N columns of storage cells or storage cell spaces of the Q/N sub-stores then together give (in particular precisely) Q columns of storage cells or storage cell spaces of the energy store. The Q columns of storage cells or storage cell spaces can correspond to a specific width of the energy store (along the transverse axis). This width (and thus also the number Q) can be kept constant for different electrical requirements (in particular for different parallel arrangements).

The energy store comprises Q/N sub-contacting systems for the corresponding Q/N sub-stores. In particular, Q/N separate sub-contacting systems can be provided for the Q/N sub-stores. Here, the individual sub-contacting systems can each be similarly structured and/or can be identical (apart from the orientation of the sub-contacting system along the longitudinal axis). In particular, the uneven sub-stores (i.e. the sub-stores with the uneven index numbers, for example 1, 3, 5, etc.) each have sub-contacting systems which are identically structured. Correspondingly, the even sub-stores (i.e., the sub-stores with the even index numbers, for example 2, 4, 6, etc.) can each have sub-contacting systems which are identically structured. The sub-contacting systems of the even sub-stores can be rotated relative to the sub-contacting systems of the uneven sub-stored through (in particular precisely) 180° about the vertical axis, but otherwise can be identical.

The energy store can thus have a cell-contacting system (CCS) which comprises Q/N sub-contacting systems for the corresponding O/N sub-stored. Here, the individual sub-contacting systems (apart from a 180° rotation about the vertical axis) can each be structured similarly and/or identically.

The Q/N sub-contacting systems can be arranged on an end face of the storage cells. In particular the Q/N sub-contacting systems can each be arranged on the same end face of the individual storage cells.

The part of the sub-contacting system for a sub-store is designed to interconnect the R*N storage cells (generally the R*Q-T storage cells) of the sub-store in question in accordance with an MP arrangement, in which the storage cells of sub-groups, each with M storage cells, are interconnected in parallel to one another. In other words, due to the sub-contacting system of a sub-store, an MP arrangement of the storage cells of this sub-store can be provided. Correspondingly, an MP arrangement of the storage cells of the sub-store in question can be provided by each of the Q/N sub-contacting systems. For this purpose, the number R*N of storage cells (generally the number R*Q−T of storage cells) of the individual sub-stores is preferably a multiple of M. In other words, (R*N)/M (or (R*Q−T)/M) is preferably a positive integer.

It should be noted here that the operator “*” or “x” represents a multiplication, and that the operator “/” represents a division.

Due to the individual sub-contacting systems, the storage cells of sub-groups each with M storage cells of the corresponding sub-store can thus be interconnected in parallel to one another. The storage cells of a sub-store can be assigned here uniquely to precisely one sub-group each, so that the storage cells of the sub-store are combined in precisely (R*N)/M sub-groups (generally (R*N−T)/M sub-groups). The sub-groups of the sub-store in question can be connected electrically conductively and/or galvanically in series with one another by the corresponding sub-contacting system.

The energy store further comprises Q/N−1 connection elements (for example lines), via which the Q/N sub-stores are interconnected in series (electrically, in particularly galvanically). The nominal voltage of the energy store can thus be effected by the series connection of the Q/N sub-stores, in particular by the series connection of the (R*N)/M sub-groups (generally of the (R*N−T)/M sub-groups) of storage cells of the Q/N sub-stores.

The energy store is constructed in such a way that the number R of rows, the number Q of columns, the number N of storage cells, the number Q/N of sub-stores. and/or the number M of storage cells interconnected in parallel are each a positive integer. Preferably, M>N.

An energy store is thus described that makes it possible, due to a division into sub-stores and due to the use of sub-contacting systems, to efficiently satisfy different electrical requirements, in particular different MP arrangements, without changing the width of the energy store (i.e., without changing the number Q of columns of storage cells). Here, an altered MP arrangement can be provided efficiently (solely) by the replacement of the sub-contacting systems.

The energy store can be designed in particular to provide a plurality of different MP arrangements of the storage cells of the Q/N sub-stores for a corresponding plurality of different values of M with constant values of Q and N by (in particular solely) adapting the Q/N sub-contacting systems for the corresponding Q/N sub-stores. The plurality of different values of M can include here in particular 3, 4, 5 and/or 6.

In particular, the values of R, Q and/or N are such that, solely by adapting the Q/N sub-contacting systems for the corresponding Q/N sub-stores, the plurality of different MP arrangements of the storage cells of the Q/N sub-stores is provided for the corresponding plurality of different values of M. Here, the plurality of different values of M possibly all include integers 1≤M≤2*N.

Ina preferred example Q=24, N=3, and 1≤M≤6. The number of rows can be R≥10 (for example R=16).

By way of a suitable dimensioning, a particularly efficient adaptation of the electrical properties (in particular of the MP arrangement) can thus be provided, without changing the geometric properties (in particular the width) of the energy store.

The Q/N sub-stores can be interconnected in series in such a way that the one or more connection elements for interconnecting an odd sub-store (i.e., a sub-store having an odd index number) to a directly subsequent sub-store (i.e., to a sub-store having an even index number) are arranged on the second transverse edge. This can be the case for all transitions from an odd sub-store to a directly subsequent sub-store.

Furthermore, the one or more connection elements for interconnecting an even sub-store to a directly subsequent odd sub-store are arranged in each case on the first transverse edge. This can be the case for all transitions from an even sub-store to a directly subsequent odd sub-store.

A series connection of the sub-stores can thus be provided particularly efficiently and reliably. Furthermore, the differential voltage between directly adjacent storage cells from different sub-stores can be kept relatively low, whereby the safety of the energy store can be increased.

The energy store can have a first terminal and a second terminal (with opposite electrical polarity). The energy store can be designed to provide the nominal voltage between the first terminal and the second terminal. The first terminal can be arranged on the first transverse edge of the first sub-store. Furthermore, the second terminal can be arranged on the first transverse edge of the Q/N^{th} sub-store. For this purpose, Q and/or N can be selected in such a way that Q/N is an even number. Due to the arrangement of the terminals on the same transverse edge of the energy store, a particularly efficient electrical connection of the energy store (for example to the electrical power-supply system of a motor vehicle) can be made possible.

The energy store can have one or more intermediate terminals on the first transverse edge of a sub-store arranged between the first and the Q/N^{th} sub-store to provide an intermediate voltage, wherein the intermediate voltage is lower than the nominal voltage. For this purpose, Q and/or N can be selected in such a way that Q/N is an even number greater than two. The flexibility of the provision of electrical energy in a vehicle can thus be increased efficiently.

The Q/N sub-stores can be interconnected in series in such a way that the discharge current flows into the one or more odd sub-stores (i.e., into the sub-stores having the odd index numbers) in the first longitudinal direction from the first transverse edge to the second transverse edge. Furthermore, the discharge current flows into the one or more even sub-stores (i.e., into the sub-stores having the even index numbers) in the opposite, second longitudinal direction from the second transverse edge to the first transverse edge. The opposite flow direction can be implemented or assisted by the opposite orientation of the various sub-contacting systems and/or by the alternating arrangement of the connection elements on the first and on the second transverse edges.

The sub-contacting system for a sub-store can have a plurality of (electrically conductive) connection arrangements of different design for the interconnection of a corresponding plurality of different sub-groups each with M storage cells. Here, the spatial arrangements of the M storage cells relative to one another in the different sub-groups can differ from one another. The connection arrangements of different design can each be designed to provide an MP arrangement of the M storage cells of the sub-group in question.

The individual sub-contacting systems can thus each be composed of a quantity of connection arrangements. In particular, (R*N)/M−1 connection arrangements can be provided for the (R*N)/M sub-groups, wherein the connection arrangements can be constructed differently at least in part (in particular when M>N). Starting from a longitudinal edge, sub-groups each with M storage cells which are arranged spatially as close to one another as possible can be formed within a sub-store. Here, only storage cells that are not already part of a preceding sub-group are always received in a subsequent sub-group. A connection arrangement adapted to the spatial arrangement of the storage cells in the sub-group in question can then be provided for each of the sub-groups. An MP arrangement can thus be provided within the individual sub-stores efficiently and reliably.

The individual sub-contacting systems can thus each have (R*N)/M−1 connection arrangements (generally (R*N−T)/M−1 connection arrangements) along the longitudinal axis. Here, connection arrangements of like design may repeat along the longitudinal axis with a specific constant repetition rate.

The sub-contacting system for a sub-store can have, for example, (in particular precisely) k connection arrangements of different design. Here, k is typically dependent on N and/or M. For example, k=3 or k=4. Each (k+1)^{th} connection arrangement along the longitudinal axis can then be of like design.

A sub-contacting system for a sub-store can thus be constructed efficiently with a limited number k of (electrically conductive) connection arrangements of different design.

The sub-contacting system for a sub-store can have (electrically conductive) first cell connectors and second cell connectors (as part of the individual connection arrangements). Here, all first cell connectors of the energy store can be of like design. Furthermore, all second cell connectors of the energy store can be of like design. Furthermore, the energy store can be formed in such a way that the energy store, apart from first cell connectors and second cell connectors, has no cell connectors of different design (apart from the connection elements between successive sub-stores). A limited number (in particular two) of cell connectors of different design can thus be used in order to electrically conductively connect the storage cells to one another in a sub-store in a particularly efficient way. Here, each connection arrangement can have, in sum, M cell connectors.

The cell connectors can each be designed to connect a first contact point (for example a positive terminal) of a storage cell from a first sub-group of the sub-store electrically conductively to a second contact point (for example a negative terminal) of a storage cell from a second sub-group of the sub-store. Here, the first contact point and the second contact point typically have different electrical polarities. Furthermore, the second sub-group follows the first sub-group preferably directly along the longitudinal axis of the energy store. A series connection of two storage cells from directly successive sub-groups can thus be provided by a cell connector.

The first cell connectors can each be designed to connect two storage cells electrically conductively to one another and at the same time to skip (in particular precisely or at most) one further storage cell arranged between the two storage cells. For this purpose, the first cell connectors can each have a (relatively long) straight form along the longitudinal axis of the energy store.

The second cell connectors can each be designed to connect two storage cells arranged directly next to one another electrically conductively to one another. For this purpose, the second cell connectors can each have a (relatively short) L-shape. The sub-contacting systems can thus be constructed particularly efficiently and reliably.

Due to the structure of an energy store described in this document, it can thus be made possible that (for example with constant variables Q and N, but with different interconnection M) the maximum length of the cell connectors of the live series interconnection can always be kept as short as possible. In particular, the length of the cell connectors can be limited to at most twice the cell diameter of the individual storage cells. A particularly efficient energy store can thus be provided.

The connection arrangements of the individual sub-contacting systems can each comprise, in particular exclusively, one or more first cell connectors and one or more second cell connectors, which are electrically conductively connected to one another. In particular, the connection arrangements each have M cell connectors (for electrical series connection of M corresponding storage cells in two directly successive sub-groups), wherein the M cell connectors of the connection arrangement in question are electrically conductively connected to one another (in order to provide a parallel connection of the M storage cells of a sub-group). For example, an MP arrangement of storage cells can thus be provided particularly efficiently.

As already presented, the energy store described in this document can have Q columns and R rows with storage cells or storage cell spaces, which are divided into Q/N sub-stores each with N columns. Each sub-store can then have up to N*R storage cells. It may be (depending on the design of the energy store) that N*R is not divisible by M (i.e., by the desired number of parallel storage cells), but that N*R-T is divisible by M, wherein 0≤T<N (for example T=1). In this case Q/N sub-stores can be provided which each have N*R−T storage cells so that the energy store on the whole has R*Q−T*Q/N storage cells. In this case the Q/N sub-stores each comprise (R*N−T)/M sub-groups and (R*N−T)/M−1 connection arrangements.

Generally, the Q/N sub-stores can each have precisely R*N−T storage cells, with 0≤T<N, wherein (R*N−T)/M is preferably an integer.

The storage cells, in this case too, can furthermore be arranged as described in this document. In particular, the N*Q−T storage cells of the various Q/N sub-stores can be arranged at the described storage cell spaces (in Q columns and in R rows). In each of the Q/N sub-stores, however, T storage cell spaces can remain unoccupied. In a preferred example, T storage cell spaces in the row which directly borders a transverse edge of the energy store are unoccupied. Here, in the one or more odd sub-stores, the T storage cell spaces on the second transverse edge can be unoccupied and, in the one or more straight sub-stores, the T storage cell spaces on the first transverse edge can be unoccupied. In an alternative example, in the one or more odd sub-stores, the T storage cell spaces on the first transverse edge can be unoccupied and, in the one or more even sub-stores, the T storage cell spaces on the second transverse edge can be unoccupied. Furthermore, the sub-stores and/or the sub-contacting systems of the sub-stores can thus be constructed identically (apart from a 180° rotation about the vertical axis).

Due to the arrangement, described in this document, of the storage cells in Q/N sub-stores which each have an MP arrangement, a series connection of (R*N−T)/M sub-groups each with M storage cells arranged parallel to one another is provided. A sub-group can have a group voltage X (for example X between 3V and 4V) so that a store voltage of (R*N−T)/M*X is provided for each sub-store. As a result, storage cells of two directly adjacent sub-stores which are arranged on a transverse edge of the energy store have a voltage difference of (up to) (R*N−T)/M*X*2. The number of columns N per sub-store and/or the number Q/N of sub-stores can be selected in such a way that (R*N−T)/M*X*2 is the same as or less than a predefined maximum voltage (for example 200V or 220V).

N and/or Q/N can thus be such that the differential voltage between any storage cells from any two directly adjacent sub-stores cannot exceed a predefined maximum voltage, in particular 220V. By choosing N and/or Q/N it can thus be provided that the differential voltage between any pairs of directly adjacent storage cells does not exceed the maximum voltage. For example, a particularly safe and a particularly compact energy store can thus be provided (since relatively small spaces can be used between directly adjacent sub-stores).

According to a further aspect a (road) motor vehicle (in particular a passenger car or a truck or a bus or a motorbike) is described which comprises at least one of the energy stores described in this document.

It should be noted that the devices and systems described in this document can be used both alone and in combination with other devices and systems described in this document. Furthermore, any aspects of the devices and systems described in this document can be combined with one another in a versatile way. In particular, the features of the claims can be combined with one another in a versatile way. Furthermore, features placed between parentheses are to be understood as optional features.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1a shows an exemplary vehicle with an energy store for storing electrical energy.

FIG. 1b shows an exemplary mounting of an electrical energy store in a vehicle.

FIG. 2a shows an exemplary round cell.

FIG. 2b shows an exemplary electrical energy store with a plurality of round cells.

FIG. 3 shows an exemplary division of an energy store into sub-stores.

FIG. 4a shows an exemplary sub-contacting system for a sub-store for providing a 5P interconnection.

FIG. 4b shows an equivalent circuit diagram for the sub-store from FIG. 4a.

FIG. 5a shows an exemplary sub-contacting system for a sub-store for providing a 4P interconnection.

FIG. 5b shows an equivalent circuit diagram for the sub-store from FIG. 5a.

### DETAILED DESCRIPTION OF THE DRAWINGS

As discussed at the outset, the present document relates to the efficient adaptation of the electrical properties of an electrical energy store without changing the width of the energy store. In this context, FIG. 1a shows an exemplary vehicle 100 with an electrical energy store 110 for storing electrical energy and an electric drive motor 102, which is operated with electrical energy from the energy store 100. Here, the energy store 110 is typically installed within a housing in the vehicle 100.

FIG. 1b shows an exemplary mounting of an energy store 110 in a vehicle 100. The vehicle 100 can have (at least or precisely) two longitudinal members 101 which are oriented along the longitudinal axis (i.e., along the x-axis in the shown Cartesian coordinate system) of the vehicle 100. Crossmembers 102 can be arranged between the longitudinal members 101 and are oriented along the transverse axis of the vehicle 100 (i.e., along the y-axis in the shown Cartesian coordinate system). The energy store 110 can be mounted on one or more longitudinal members 101 and/or on one or more crossmembers 102 of the vehicle 100.

An installation space for the energy store 110 with a defined width 111 can be provided between the longitudinal members 101. The width 111 of the installation space can be uniform for different vehicle models. Furthermore, the electrical connections 121, 122 for electrical connection of the energy store 110 to the electrical power-supply system and/or to the drive motor 102 can be arranged on a defined side of the energy store 110 (along the longitudinal axis of the vehicle 100 before or after the energy store 110).

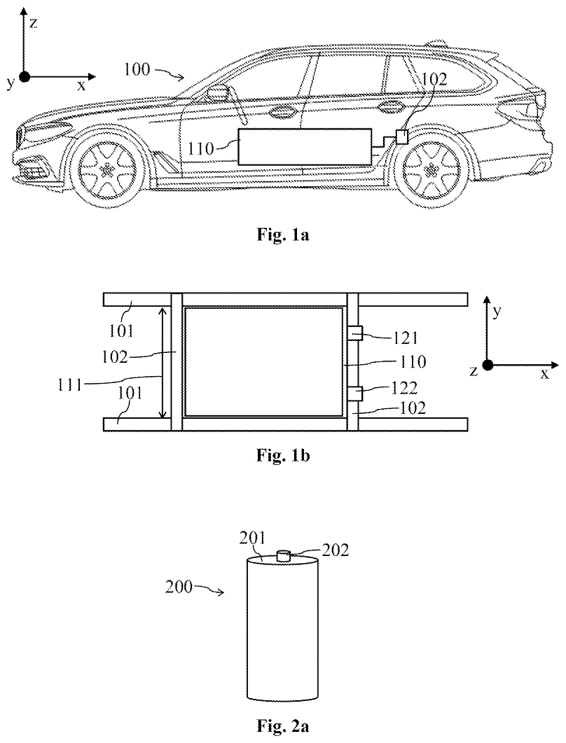

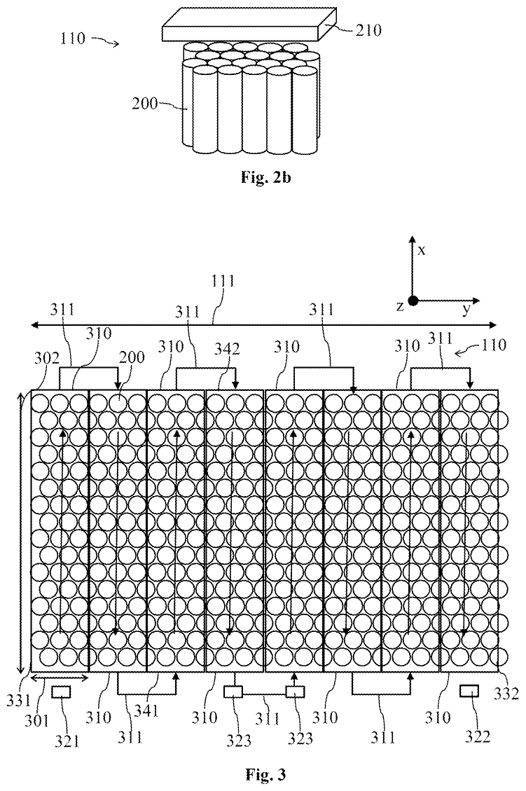

The energy store 110 comprises a plurality of storage cells, in particular round cells. FIG. 2a shows an exemplary storage cell 200, in particular a round cell, for an electrical energy store 110. The storage cell 200 has a circular-cylindrical shape. A positive contact point 201 and a negative contact point 202 for electrical connection of the storage cell 200 are arranged on an end face of the storage cell 200. The positive contact point 201 can be formed here by the end face of the cylindrical storage cell 200. The negative contact point 202 can be formed by a pin which protrudes from the end face of the storage cell 200. In a further example the polarity of the contact points 201, 202 can be exactly the reverse.

FIG. 2b shows an exemplary electrical energy store 110, which has a plurality of storage cells 200 which are arranged next to one another side to side (i.e. lateral surface to lateral surface), in particular in such a way that the contact points 201, 202 of the individual storage cells 200 are arranged on the same side (in FIG. 2b on the upper side). The energy store 110 can have, for example, 100 or more storage cells 200, or 1000 or more storage cells 200.

The individual storage cells 200 can be electrically conductively connected to one another via a cell-contacting system 210. The cell-contacting system 210 can have, for example, a frame with connection lines for electrically contacting the contact points 201, 202 of the individual storage cells 200. The cell-contacting system 210 can be arranged on the side of the storage cells 200 on which the contact points 201, 202 of the storage cells 200 are arranged. A housing wall of a housing of the energy store 110 can be arranged on the opposite side of the storage cells 200 (not shown). The opposite housing wall can be formed for example as a cooling plate for cooling the individual storage cells 200.

As shown in FIG. 2b, the (circular-cylindrical) storage cells 200 can be arranged in such a way that the lateral surfaces of directly adjacent storage cells 200 touch one another. Here, the storage cells 200 can be arranged next to one another in a honeycomb form, in particular in such a way that a cavity is enclosed in each case by a sub-group of three storage cells 200, and/or in such a way that six storage cells 200 in each case surround precisely one further storage cell 200. For example, the (circular-cylindrical) storage cells 200 can be arranged particularly densely. The circular-cylindrical storage cells 200 can be arranged in particular in the arrangement with the greatest possible packing density.

FIG. 3 shows a plan view of an electrical energy store 110 which in the shown example has 24 columns of storage cells 200 and 16 rows of storage cells 200. The energy store 100 thus comprises 24×16 storage cells. Generally, the electrical energy store 110 can have Q columns and R rows of storage cells 200, and thus Q×R storage cells 200.

The energy store 110 shown in FIG. 3 can be installed in a vehicle 100 in such a way that the Q columns each run along the transverse axis of the vehicle 100 (as shown by the coordinate system in FIG. 3). The energy store 100 can thus be a certain overall width 111, which is given by the defined amount of Q storage cells 200 per row of the energy store 110.

The energy store 110 can be divided along the transverse axis (i.e., along the y-axis) into a plurality of sub-stores 310, wherein in the shown example each sub-store 310 has N=3 columns with storage cells 200. The energy store 100 can thus be divided into Q/N sub-stores 310 which each have N columns with storage cells 200 (wherein Q/N=8 in the shown example). A sub-store 310 has a certain width 301, which typically corresponds to 1/Q of the total width 111). Furthermore, a sub-store 310 has a length 302 (along the longitudinal axis or the x-axis) corresponding to the total length of the energy store 110 and dependent on the number R of rows of the arrangement of storage cells 200 of the energy store 100.

The energy store 110 can extend along the longitudinal axis from a first longitudinal edge 331 to an opposite second longitudinal edge 332. Correspondingly, the energy store 100 can extend along the transverse axis from a first transverse edge 341 to an opposite second transverse edge 342. The Q/N sub-stores 310 can each extend along the longitudinal axis from the first longitudinal edge 331 to the second longitudinal edge 332. Furthermore, the Q/N sub-stores 310 can be arranged sequentially next to one another along the transverse axis so that the first sub-store 310 is arranged on the first transverse edge 341 of the energy store 110 and so that the Q/N^{th} sub-store 310 is arranged on the second transverse edge 342 of the energy store 110.

The sub-stores 310 can be interconnected in series in a meandering manner. Here, the first sub-store 310 (at the first transverse edge 341 of the energy store 110) can be passed through in a first longitudinal direction (shown by the arrow oriented upwards). The first longitudinal direction runs here from the first longitudinal edge 331 in the direction of the second longitudinal edge 332. The second sub-store 310 following on therefrom directly can be passed through in a (opposite) second longitudinal direction (shown by the arrow oriented downwards). The second longitudinal direction runs here from the second longitudinal edge 332 in the direction of the first longitudinal edge 331. The electrical terminals, arranged at the second longitudinal edge 332, of the first sub-store 310 and of the second sub-store 310 following on therefrom directly can be connected electrically conductively to one another by a connection element 311.

All odd sub-stores 310 can thus be passed through along the first longitudinal direction (by a discharge current), and all even sub-stores 310 can be passed through along the second longitudinal direction (by the discharge current). Further, each odd sub-store 310 can be connected electrically conductively to the directly successive even sub-store 310 at the second longitudinal edge 332 via a connection element 311. Furthermore, each even sub-store 310 can be connected electrically conductively to the directly successive odd sub-store 310 at the first longitudinal edge 331 via a connection element 311. A meandering series connection of the sub-stores 310 can thus be provided efficiently.

The number Q/N of sub-stores 310 is preferably an even number. As a result, the first terminal 321 (for example the positive terminal) and the second terminal 322 (for example the negative terminal) can be arranged on the same transverse edge 341 of the energy store 110. The first terminal 321 can be arranged here on the first sub-store 310, in particular at the input of the first sub-store 310) and the second terminal 322 can be arranged on the Q/N^{th} sub-store 310, in particular at the output of the Q/N^{th} sub-store 310. A particularly efficient connection of the energy store 110, in particular of the terminals 321, 322, at the corresponding contact points 121, 122 of the vehicle 100 can thus be made possible.

The nominal voltage of the energy store 110 (for example 800V) can be provided between the terminals 321, 322 of the energy store 110. The division of the energy store 110 into Q/N sub-stores 310 makes it possible to provide sub-voltages of the nominal voltage via one or more intermediate terminals 323. An intermediate terminal 323 can be arranged on a sub-store 310 which is arranged between the first and the O/N^{th} sub-store 310. Here, the one or more intermediate terminals 323 can preferably be arranged on the same transverse edge 341 as the main terminal 321, 322 (as shown by way of example in FIG. 3) in order to allow an efficient connection of the energy store 110.

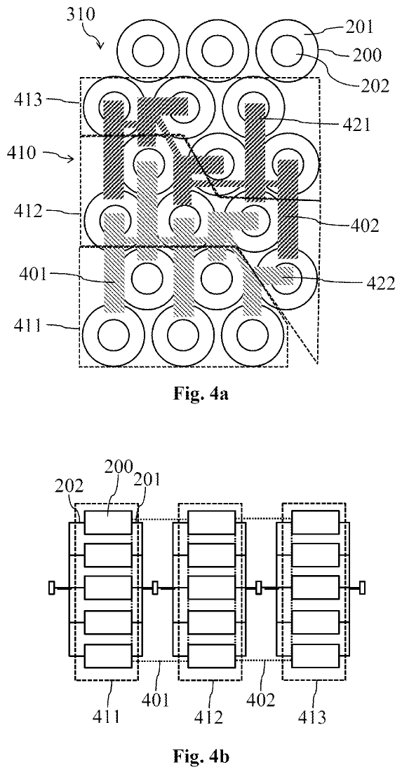

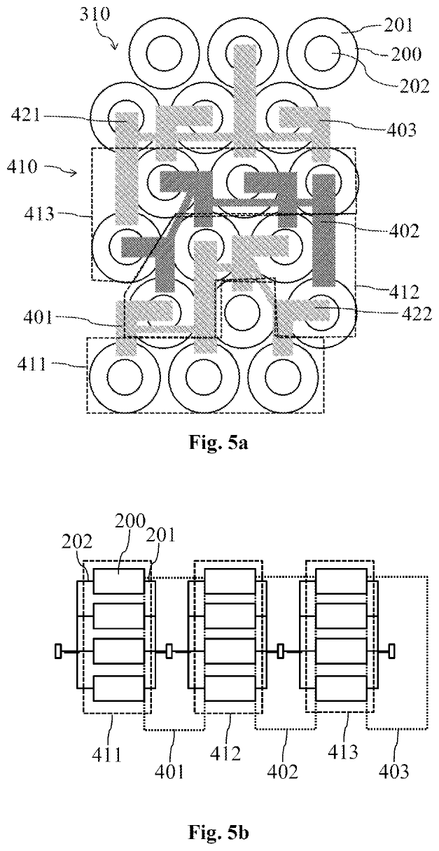

The division of the energy store 110 into sub-stores 310 is preferably associated with a corresponding division of the cell-contacting system 210 into different sub-contacting systems 410 for the different sub-stores 310 (as shown by way of example in FIGS. 4a and 5a). The cell-contacting system 210 for the energy store 110 can thus have Q/N (identically constructed) sub-contacting systems 410 for the corresponding Q/N sub-stores 310.

Due to the sub-contacting system 410 of a sub-store 310, a specific electrical arrangement of the storage cells 200 of the sub-store 310 can be provided. Exemplary electrical arrangements are
3P, in which sub-groups each of three storage cells 200 connected in parallel are arranged in series with one another;
4P, in which sub-groups each of four storage cells 200 connected in parallel are arranged in series with one another;
5P, in which sub-groups each of five storage cells 200 connected in parallel are arranged in series with one another;
6P, in which sub-groups each of six storage cells 200 connected in parallel are arranged in series with one another; and/or

MP, in which sub-groups each of M storage cells 200 connected in parallel are arranged in series with one another.

It can be shown that, for a sub-store 310 which has R rows each with N storage cells 200, all MP arrangements, with 1≤M≤2N, can be provided by a suitable sub-contacting system 410.

In FIG. 4a a detail of an exemplary sub-contacting system 410 for a 5P arrangement of a sub-store 310 with N=3 columns of storage cells 200 is shown. By way of a first (electrically conductive) connection arrangement 401, the first contact points 201 of the storage cells 200 of a first sub-group 411 of M=5 storage cells 200 are electrically conductively connected to one another. Furthermore, due to the first connection arrangement 401, the second contact points 202 of the storage cells 200 of a second sub-group 412 of M=5 storage cells 200 are electrically conductively connected to the first contact points 201 of the storage cells of the first sub-group 411. Further, due to a second connection arrangement 402, the first contact points 201 of the storage cells 200 of the second sub-group 412 of storage cells 200 are electrically conductively connected to one another. Furthermore, due to the second connection arrangement 402, the second contact points 202 of the storage cells 200 of a third sub-group 413 of M=5 storage cells 200 are electrically conductively connected to the first contact points 201 of the storage cells of the second sub-group 412.

Differently constructed connection arrangements 401, 402 can thus be used to electrically conductively connect different formed sub-groups 411, 412, 413 of, in each case, M=5 storage cells 200 to one another. Here, the storage cells 200 of a sub-group 411, 412, 413 can be connected parallel to one another in each case. Furthermore, sub-groups 411, 412, 413 following one another directly can be interconnected in series. This is shown by way of example by the circuit diagram in FIG. 4b.

As can be seen from FIG. 4a the forms of the sub-groups 411, 412, 413 and the corresponding forms of the connection arrangements 401, 402 repeat with a specific repetition rate along the longitudinal axis of the sub-store 310. In the example shown in FIG. 4a, each fourth sub-group and/or each fourth connection arrangement has the same form.

FIG. 5a shows exemplary sub-groups 411, 412, 413 and corresponding connection arrangements 401, 402, 403 for an M=4 arrangement in a sub-store with N=3 columns of storage cells 200. FIG. 5b shows the corresponding circuit diagram.

An energy store 110 with a specific nominal voltage (for example 800 V) and with a specific width 111 (for example of Q=24 cell columns) can thus be divided into N columns (for example with N=3). This is advantageous in particular in order to provide four store connections 321, 322, 323 on a common transverse edge 341 of the storage module 110. The storage cells 200 of the N columns (i.e., the sub-stores 310) can each be interconnected (in series) via differently embodied cell connectors 421, 422. Here, a relatively long (first) cell connector 421 can be used which allows cells to be skipped. Furthermore, a relatively short (second) cell connector 422 can be used which connects directly adjacent cells 200 to one another.

In order to produce the parallel connection between a sub-group 411, 412, 413 of storage cells 200, the individual series cell connectors 421, 422 can be combined and/or electrically conductively connected to one another in sub-groups of M (for an MP connection).

Due to the division of the store 110 into Q/N (for example 8) columns (in the case of an 800 V system), the maximally expected voltage difference between the individual columns of the cells 200 is ˜200 V. Due to the use of different connection arrangements 401, 402, 403, different MP interconnections can be provided (for different values of M).

The measures described in this document make it possible to provide different electrical interconnections efficiently and in a flexible way in an energy store 110 of fixed width 111 (i.e., with a fixed number Q of cell columns). Further, this can cause the voltage differences between locally directly adjacent storage cells 200 to be relatively small. In addition, relatively long electrical cell connections and/or relatively long electrical connections to the electrical power-supply system of a vehicle 100 can be avoided.

The present invention is not limited to the presented exemplary embodiments. In particular it is noted that the description and the figures are intended to illustrate the principle of the proposed methods, devices and systems only by way of example.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof

What is claimed is:

1. An energy store for storing electrical energy; the energy store comprising:
storage cells which are arranged in R rows and Q columns, wherein the energy store is divided into Q/N sub-stores which have the storage cells in R rows and N columns;
Q/N sub-contacting systems for the corresponding Q/N sub-stores, wherein a sub-contacting system for a respective sub-store is configured to interconnect the storage cells of the respective sub-store in accordance with an MP arrangement in which storage cells of sub-groups, each with M storage cells, are interconnected in parallel to one another; and
Q/N−1 connection elements, via which the Q/N sub-stores are interconnected in series;
wherein each of R, Q, N, Q/N, and M is a positive integer.

2. The energy store according to claim 1, wherein:
the energy store is configured to provide a plurality of different MP arrangements of the storage cells of the Q/N sub-stores for a corresponding plurality of different values of M with constant values of Q and N by adapting the Q/N sub-contacting systems for the corresponding Q/N sub-stores; and
the plurality of different values of M comprises 3, 4, 5 and/or 6.

3. The energy store according to claim 2, wherein values of R, Q and N are such that, solely by adapting the Q/N sub-contacting systems for the corresponding Q/N sub-stores, the plurality of different MP arrangements of the storage cells of the Q/N sub-stores is provided for the corresponding plurality of different values of M.

4. The energy store according to claim 2, wherein each of the plurality of different values of M all comprises an integer 1≤M≤2*N.

5. The energy store according to claim 1, wherein:
Q=24;
N=3;
R≥10; and
1≤M≤6.

6. The energy store according to claim 1, wherein:
the Q/N sub-stores are arranged next to one another along a transverse axis so that a first sub-store is arranged on a first longitudinal edge and a Q/N^{th} sub-store is arranged on an opposite second longitudinal edge of the energy store;
the R rows of storage cells are arranged along a longitudinal axis between a first transverse edge and a second transverse edge of the energy store; and
the Q/N sub-stores are interconnected in series such that:
the one or more connection elements for interconnecting an odd sub-store to a directly subsequent sub-store are arranged on the second transverse edge; and
the one or more connection elements for interconnecting an even sub-store to a directly subsequent odd sub-store are arranged on the first transverse edge.

7. The energy store according to claim 6, wherein:
the energy store has a first terminal and a second terminal;
the energy store is configured to provide a nominal voltage of 800 V or more between the first terminal and the second terminal;
the first terminal is arranged on the first transverse edge of the first sub-store; and
the second terminal is arranged on the first transverse edge of the Q/N^{th} sub-store.

8. The energy store according to claim 7, wherein:
the energy store has one or more intermediate terminals on the first transverse edge of a sub-store arranged between the first and the Q/N^{th} sub-store to provide an intermediate voltage; and
the intermediate voltage is lower than the nominal voltage.

9. The energy store according to claim 6, wherein the Q/N sub-stores are interconnected in series such that:
a discharge current flows into one or more odd sub-stores in a first longitudinal direction from the first transverse edge to the second transverse edge; and
the discharge current flows into one or more even sub-stores of the discharge current in an opposite, second longitudinal direction from the second transverse edge to the first transverse edge.

10. The energy store according to claim 1, wherein:
the sub-contacting system for the respective sub-store has a plurality of connection arrangements of different design for interconnection of a corresponding plurality of different sub-groups, each with M storage cells;
spatial arrangements of the M storage cells relative to one another in the different sub-groups differ from one another; and
the connection arrangements of different design are each configured to provide an MP arrangement of the M storage cells of a respective sub-group.

11. The energy store according to claim 10, wherein:
the sub-contacting system for the respective sub-store has a specific number of connection arrangements along the longitudinal axis; and
the sub-contacting system for the respective sub-store has the connection arrangements of like design with a constant repetition rate along the longitudinal axis.

12. The energy store according to claim 11, wherein:
the sub-contacting system for the respective sub-store has k connection arrangements of different design;
each (k+1)^{th} connection arrangement along the longitudinal axis is of like design; and
k=3 or k=4.

13. The energy store according to claim 1, wherein:
the sub-contacting system for the respective sub-store has first cell connectors and second cell connectors;
each of the cell connectors is configured to connect a first contact point of a first storage cell from a first sub-group, with M storage cells, of the sub-store electrically conductively to a second contact point of a second storage cell from a second sub-group, with M storage cells, of the sub-store;
the first contact point and the second contact point have different electrical polarities; and
the second sub-group follows the first sub-group directly along a longitudinal axis of the energy store.

14. The energy store according to claim 13, wherein:
the first cell connectors are each configured to connect two storage cells electrically conductively to one another and to skip one further storage cell arranged between the two storage cells; and
the second cell connectors are each configured to connect two storage cells arranged directly next to one another electrically conductively to one another.

15. The energy store according to claim 14, wherein:
the first cell connectors each have a straight form along the longitudinal axis of the energy store; and/or
the second cell connectors each have an L-shape.

16. The energy store according to claim 13, wherein:
all first cell connectors of the energy store are of like design;
all second cell connectors of the energy store are of like design; and/or
the energy store, apart from the first cell connectors and the second cell connectors, has no cell connectors of different design.

17. The energy store according to claim 13, wherein:
the sub-contacting system for the respective sub-store has a plurality of connection arrangements of different design for interconnection of a corresponding plurality of different sub-groups, each with M storage cells;
spatial arrangements of the M storage cells relative to one another in the different sub-groups differ from one another;
the connection arrangements of different design are each configured to provide an MP arrangement of the M storage cells of a respective sub-group; and
the connection arrangements each comprise one or more first cell connectors and one or more second cell connectors, which are electrically conductively connected to one another.

18. The energy store according to claim 1, wherein:
the Q/N sub-stores each have R*N−T storage cells;
0≤T<N; and
(R*N−T)/M is an integer.

19. The energy store according to claim 1, wherein N and/or Q/N are such that a differential voltage between any storage cells from any two directly adjacent sub-stores does not exceed a predefined maximum voltage of 220 V.

20. The energy store according to claim 1, wherein:
the storage cells are each circular-cylindrical;
the storage cells are round cells;
the Q/N sub-contacting systems are arranged on an end face of the storage cells; and/or
the storage cells are arranged in a honeycomb pattern in the R rows and the Q columns.
